(19) United States
(12) Patent Application Publication
(10) Pub. No.: US 2006/0045018 A1
(43) Pub. Date: Mar. 2, 2006

(54) Device, system and method for varying scanning time on a channel

(76) Inventor: Ahmad Masri, Nahif Village (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/924,778

(22) Filed: Aug. 25, 2004

(51) Int. Cl. H04L 12/26

(52) U.S. Cl. 370/241; 370/338

(57) ABSTRACT

A method, device and system for varying the duration of active scanning of a channel in response to noise detected on such channel. If a device detects no noise on such channel, and no probe response is received to the device's probe request, then the duration of scanning on such channel may be limited to a brief dwell time. If noise is detected on such channel then the duration of scanning on such channel may be extended to a longer dwell time.

### BACKGROUND OF THE INVENTION

A device, such as for example a network interface card (NIC) or another device that facilitates wireless communication, that seeks to associate with a wireless network such as for example a wireless local area network (WLAN) may scan a set of channels looking for a basic service set (BSS) such as for example those that may be made available by a peer or an access point (AP) or by some other device that provides wireless access to a network or WLAN. There may be several methods of scanning, for example, passive scanning and active scanning. In active scanning a device may transmit a probe request on each of a series of channels. The device may then wait for a probe response to its probe request on such channel from for example an AP or other device which may be available for association on such channel.

A device may actively scan from several to up to 17 or more channels as part of an active scanning process. The device may remain tuned to a channel being scanned for from for example 5 to 30 miliseconds before proceeding to a next channel to be scanned. Other periods may be used. The period during which a device remains tuned to a channel during an active scan may be known as a dwell period. Long dwell periods may for example reduce the throughput of a device and increase the device's power consumption.

### BRIEF DESCRIPTION OF THE DRAWINGS

Embodiments of the invention will be understood and appreciated more fully from the following detailed description taken in conjunction with the drawings in which:

FIG. 1 is a schematic diagram of components of a wireless device and of a network in accordance with an exemplary embodiment of the invention;

FIG. 2 is a flow diagram depicting a data flow for a method of varying scanning time on a channel in accordance with an exemplary embodiment of the invention;

FIG. 3 is a flow chart describing a method for saving data on detected APs in accordance with an embodiment of the invention; and

FIG. 4 is a flow chart describing a method in accordance with an embodiment of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention. Various examples are given throughout this description. These are merely descriptions of specific embodiments of the invention. The scope of the invention is not limited to the examples given.

Unless specifically stated otherwise, as apparent from the following discussions, it is appreciated that throughout the specification, discussions utilizing terms such as “processing,” “computing,” “calculating,” “determining,” or the like, refer to the action and/or processes of a processor, computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computer, processor, communication device, communication or other standard, or other apparatus. The desired structure for a variety of these systems will appear from the description below. In addition, embodiments of the present invention are not described with reference to any particular programming language, machine code, etc. It will be appreciated that a variety of programming languages, machine codes, etc. may be used to implement the teachings of the invention as described herein. In some embodiments, an article including a storage medium may store instructions that when executed may result in the performance of an embodiment of the invention.

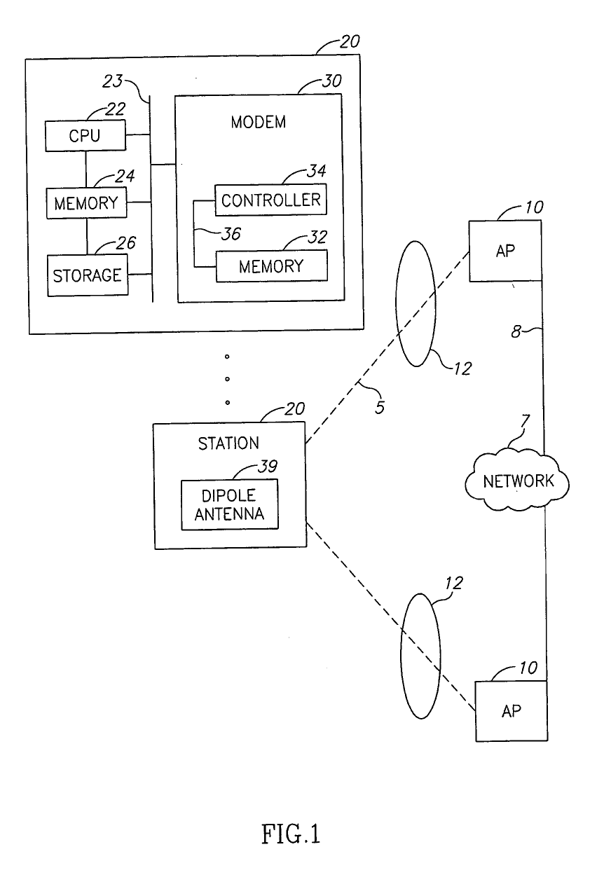

Reference is made to FIG. 1, a schematic diagram of components of a station and a network in accordance with an exemplary embodiment of the invention. Network 7 may for example include one or more peers or other units, such as for example wireless mobile units and one or more providers of a BSS such as for example an AP 10, which may facilitate an association between a wireless device such as for example a station 20 and a network 7. Network 7 may for example be a wireless network or a network that may include wireless components. For example, in some embodiments, network 7 may be a local area network (LAN) with wireless links, such as a WLAN. In other embodiments, network 7 may be for example a wide area network (WAN). A BSS provider such as for example an AP 10 may in some embodiments associate wireless devices such as for example stations 20 with other equipment such as for example personal computers, workstations, printers, etc. A provider of a BSS such as for example AP 10 may be linked to network 7 by wireless communication or by wires 8. Network traffic 5 between a wireless device such as for example a station 20 and a provider of a BSS such as AP 10 may for example be radio waves carrying digital data. Alternatively, traffic 5 may be in different forms such as for example infrared or other electromagnetic waves. In other embodiments, the various devices communicating on a network 7 need not be stations 20 or APs 10 or the other specific devices mentioned herein. Other network configurations or network devices with different configurations, protocols or structures may be included in embodiments of the invention disclosed herein.

Station 20 may include, for example, a processor 22 (e.g., one or more central processing units (CPUs) or microprocessors), a memory or storage unit 24 (e.g., one or more random access memories (RAMs) or read only memories (ROMs)), mass storage unit 26 (e.g., a hard disk, a floppy disk, a compact disk, a removable memory or other non-volatile memory), one or more busses 23, and a modem such as for example a wireless modem 30. Wireless modem 30 may include standard computational components, such as, for example, a controller 34, such as for example a microprocessor, CPU, etc, a memory 32, and one or more busses 36. Station 20 or modem 30 may in some embodiments include other components such as for example an antenna such as a dipole antenna 39, a mutli-dimensional antenna, an omni-directional antenna or other types of antennas.

In an exemplary embodiment of the invention, a communications device such as station 20 may seek to associate with network 7, and may through for example active scanning, scan channels 12 looking for a suitable transmission source such as BSS or AP 10 to facilitate the association. For a channel to be scanned, a controller or processor 22 may set an indicator or variable such as for example a SILENT variable in memory 32 to TRUE. Other variables may be used and other indicators or data storage facilities may be used. If at any time during the scanning of such channel 12, station 20 detects wireless transmissions or broadcasts on such channel 12, a processor 22 or controller 34 may change the setting of for example a SILENT variable to FALSE as an indication that it has detected traffic 5, wireless transmissions or other network noise on such channel 12. Station 20 may check or listen for traffic 5, transmissions, network traffic or other noise or transmitted signals from a wireless network on channel 12 one or more times before and/or after station 20 transmits a probe request on such channel 12. Once a probe request is transmitted, station 20 may listen for a probe response from for example an AP 10 that may be in the area of such station 20 or from another device that may be transmitting on such channel 12. If no AP 10 responds to a probe request on a particular channel 12, and a SILENT indicator in station 20 for such channel is still set to TRUE, thereby indicating that there are no active transmissions on such channel 12, then station 20 may vary the time of, abbreviate, cut short or otherwise terminate its scan on such channel 12, since it may be unlikely that there are then active transmissions on such channel 12, and therefore unlikely that there is an AP 10 active in such area on such channel 12. In such case, station 20 may proceed to a next channel 12 to be scanned.

If on the other hand, during the course of a scan of a channel 12, the SILENT indicator has been set to FALSE, indicating that noise has been detected on such channel 12, such setting may be an indication that there are active wireless transmissions on such channel 12, and that an AP 10 may be available for association on such channel 12. In for example such case, or for example if a probe response from an AP 10 has been received by station 20 on such channel 12, then station 20 may vary the time of, increase or otherwise extend the length or duration of the period during which it scans such channel 12 before proceeding to a next channel 12 to be scanned.

In some embodiments, if no noise has been detected on a channel 12 and no APs 10 have issued a probe response to the station's 20 probe request, the duration of the scan may be limited to a brief dwell period of for example 2 to 3 miliseconds. Other brief periods may be used. If noise has been detected on a channel 12 or an AP 10 has issued a probe response to a probe request on such channel 12, then for example a processor 22 in such station 20 may vary or increase the scan time to for example an extended dwell period on such channel 12 for up to for example 30 miliseconds. Other scan periods and other variations from for example a default scan period may be used. For example, a scan period may be initially set as a brief dwell period of for example 2-3 miliseconds and such dwell period may be increased or extended in increments of for example several milliseconds for each other station 20 that is detected as transmitting on a given channel 12 or for each AP 10 or BSS that responds to a probe request.

In some embodiments, a scanning process may be undertaken even after a device is associated in an attempt, for example, to improve reception or transmission quality. The group or set of channels 12 that may be scanned by station 20 may, in an exemplary embodiment, be identified by a processor or controller such as for example processor 22 or by controller 34 based on for example a list or table of one or more channels 12 that may be stored in for example a memory 32 of a modem. Such table may include a record of channels 12 that may be used for transmissions with a particular WLAN or service set, or as may for example be in use for transmissions in the area or location of a particular BSS or AP 10.

A provider of a BSS such as for example an AP 10 may be for example a wireless transmitter or wireless transmission device such as for example a wireless bi-directional communications link or wireless interface means through which wireless devices such as, for example station 20, may associate with a network such as network 7. Other communications links, having structures and functionalities other than those of a BSS or AP 10 may be used.

Station 20 may be or include a wireless communication device. For example, station 20 may for example be a personal computer which may for example be portable (e.g., a “laptop”, a personal digital assistant, etc.) and which may include wireless modem 30. Wireless modem 30 may be, for example, a mini-PC wireless network adaptor or may be another type of wireless communications device. Station 20 may be or include other computing devices, such as for example cellular telephones, etc.

Network 7 may in certain embodiments be a WAN such as for example the Internet, a WLAN such as, for example, those that may connect a LAN to wireless stations, or smaller networks such as those used by components based on for example, the Bluetooth standard, such as scatternets, micronets or piconets, etc.

Either or both of processor 22 or controller 34 may act as a controller or processor to carry out a method or be part of a device according to an embodiment of the present invention; other controllers or processors may be used. Similarly, memory 32, storage unit 24 and data storage unit 26 may alone or in combination store data to carry out the method, or may be part of a device in accordance with the present invention. While in FIG. 1 such components are shown in only one station 20, other stations 20 may include similar components. Some stations 20 may include different sets of components and different functionalities, and may carry out the methods discussed herein in different manners. In other embodiments, having equipment with different configurations, different components may act as a controller 34 or processor 22 for the invention described herein.

In some embodiments, a BSS or AP 10 may communicate or associate with station 20, with network 7, with other wireless components, or with other APs 10. For example, AP 10 may communicate with station 20 using packets, frames or other discreet units of information, to provide station 20 with access to network 7. In some embodiments, AP 10 may operate on a single frequency or channel 12 (represented in FIG. 1 by a set of traffic 5) and may provide a BSS to clients such as for example station 20 on such channel 12. In some embodiments, a single AP 10 may operate in an area, although multiple APs 10 may operate in an area and on the same or on different channels 12 if, for example, demand warrants. Other systems for providing access to network 7 are possible.

In an exemplary embodiment, a station 20 may through active scanning, scan channels 12 in for example an attempt to associate with a network 7 by way of a BSS in such area. Such an attempt may be initiated, for example, at the beginning of a network session in order to associate or establish access between a station 20 and a service set or network 7, or, during a network session for reasons such as for example finding a better path for access to the network 7. Other reasons for scanning during an association session may include for example accessing another network 7 component, or as a result of moving a station 20 out of range of one AP 10 and into the range of another AP 10. In some circumstances an association between a station 20 and a BSS or AP 10 may be inadvertently or momentarily lost, and a scan may be undertaken by a station 20 to reestablish the association with the same or another BSS or AP 10. In some embodiments a station 20 may scan channels 12 on a regular basis while it is already associated with an AP 10 to determine for example if it can improve the transmission quality of its association. Other factors may trigger a scan of channels 12 by a station 20.

In attempting to associate, a station 20, possibly by way of modem 30, may actively scan some or all of the channels 12 upon which it may be able to transmit and receive signals. In some embodiments, active scanning may entail tuning a receiver or other signal receiving device of station 20 or modem 30 to a channel 12 and broadcasting a signal such as for example a probe request to find a BSS or AP 10. A BSS or AP 10 which receives such a request may answer with a probe response to alert the station 20 as to its availability. This process may be repeated for some or all of channels 12 on which station 20 may be capable of receiving or transmitting signals.

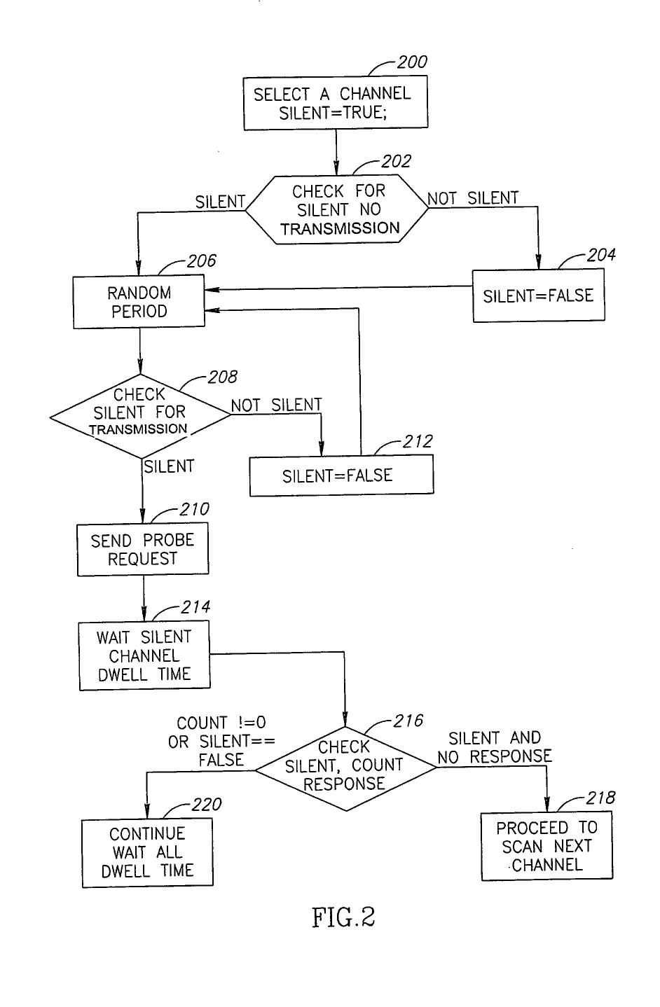

Reference is made to FIG. 2, a flow diagram depicting a data flow for a method of varying scanning time on a channel in accordance with an exemplary embodiment of the present invention. In block 200, a processor or controller may select a channel to be scanned and may set an indicator or variable such as for example a SILENT indicator that may be stored in a memory of the device to TRUE or to some other initial default setting that may for example indicate that traffic, transmissions or other network noise has not been detected or heard on such channel. Other default or initial settings are possible. In block 202, a device such as a station may listen or otherwise monitor a channel selected for scanning to check for silence or a lack of network transmission noise on such channel, and to determine whether there is transmission noise from one or more other stations, APs or other devices already transmitting or broadcasting on such channel. If such check determines that there is silence or no detected traffic, transmissions or other network noise on such channel, the method may continue to block 206. If there is traffic, transmission or other network noise detected on such channel such that such channel is not silent or noise free, the method may continue to block 204. In block 204, the method may set the SILENT variable to FALSE to record that traffic, transmissions or other network noise have been detected on such channel. In block 206 where a processor or controller of the device may set for example a random time delay that may be counted down by the device before a check is made again to determine if the channel is silent or noise free. The method may proceed to block 208.

In block 208, the device may listen or otherwise monitor a channel to check for silence on such channel and determine whether there is traffic, transmission or other network noise from one or more other stations, APs or other devices already transmitting or broadcasting on such channel. If such check determines that there is silence or lack of noise on such channel, the method may continue to block 210. If there is traffic, transmissions or network noise detected on such channel such that such channel is not silent, the method may continue to block 212 where a controller or processor may set the SILENT variable to FALSE to indicate that traffic, transmissions or other network noise were detected on such channel. The method may return to block 206 where the device may be set to wait another random period before again checking for silence on the channel to be scanned.

Returning to block 210, if traffic, transmissions or other network noise were not detected on the channel being scanned, such that the channel is silent, the device may transmit a probe request to solicit probe responses from any devices such as APs or other BSS in the area or vicinity of the device on the channel being scanned. The method may proceed to block 214 where the device may wait a brief dwell period for a probe response to answer its probe request.

At some point, preferably before block 216, a controller or processor may designate in for example the device's memory a variable such as a COUNTER that may track or record the number of AP's, BSS or other devices that may issue for example a probe response to the device's probe request or that the device has detected or heard as producing traffic, transmissions or other network noise on a particular channel.

The method may proceed to block 216 where the device may listen for a probe response or for any other traffic, transmissions or network noise that it may detect on the channel selected for scanning. In block 216, if after a brief dwell period the device does not receive any probe responses, does not detect any traffic, transmission or network noise on the channel being scanned, and the SILENT variable is set to TRUE, the method may proceed to block 218. If during the brief dwell period, the device detects traffic, transmissions or network noise on the channel being scanned, a processor or controller may set the SILENT variable to FALSE. Similarly, if during the brief dwell period the device receives one or more probe responses, as may in some embodiments be evidenced by the COUNTER variable having a value of other than 0, the method may proceed to block 220.

In block 218, the device may, after having scanned the selected channel for only a brief dwell time, terminate its scan of the channel and proceed to a next channel to be scanned.

In block 220, a processor or controller of for example the device may extend, delay or otherwise vary the dwell or scanning time of a device on such channel and may continue the scan for a period equal to for example an extended dwell time. Other operations or series of operations may be used.

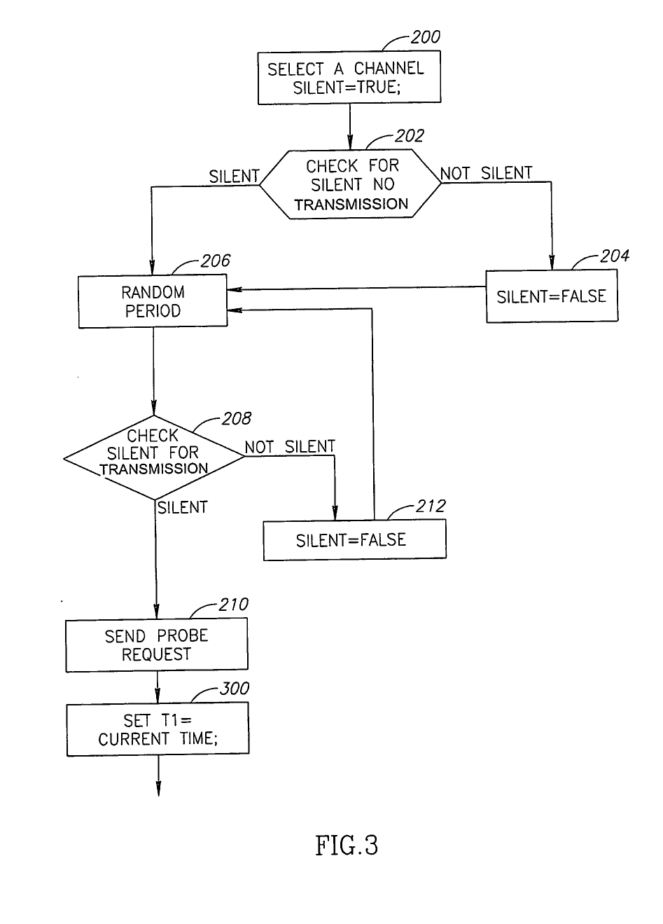

Reference is made to FIG. 3, a flow chart describing a method for saving data on detected APs in accordance with an embodiment of the invention. In an embodiment of the invention a method may include actions described in blocks 200 through 212 of FIG. 2, or may include other suitable series of operations. In block 300 a variable such as for example variable T1 may be set with a numeric or other representation of the time of the sending of a probe request for example as is described in block 210. In some embodiments the time may be a time of day. In some embodiments the time may be a figure representing the time lapsed since the selection of a channel in block 200 or since some other event. Other variables may be used and other representations, calculations or time indexes may be used. The method may proceed to block 302 where the device may wait a brief dwell period of for example 2-3 miliseconds (other time periods may be used) for a probe response to its probe request. Other brief periods that are less than a full channel dwell time may be used. Such brief period may in some embodiments be called a silent channel dwell period. The method may proceed to block 304 where a device may listen for a probe response and for any other noise or transmissions that it may detect on the channel. If the device detects or hears a probe response or other traffic, transmission or network noise on the channel, a variable such as for example a silent variable may be set to FALSE and the method may proceed to block 306. If the device does not detect a probe response or other traffic, transmission or network noise on the channel, the method may proceed to block 308.

In block 308, the device may terminate its scan of the channel and proceed to a next channel to be scanned.

Returning to block 306, a determination may be made by for example a processor or other component within the device as to whether the total time elapsed in scanning the current channel exceeds a pre-determined time span. In some embodiments such pre-determined time span may be for example 25-30 milliseconds and may be designated as the all dwell time. Other designations and other pre-determined time spans may be used. In some embodiments the total time elapsed in scanning the current channel may be determined by calculating a difference between a current time and the time entered as T1 in block 300. Other calculations of the total elapsed scanning time on a channel are possible. If the total elapsed scanning time span on a channel is less than the pre-determined scanning time span, the method may continue to block 309. If the total elapsed scanning time is greater than the pre-determined scanning time span, the method may continue to block 310.

In block 309, the device may record or store in a memory an identification number or identifying characteristic of for example an AP or other device that may have been detected as transmitting on the channel being scanned. Other information such as the quality, security status, speed or other characteristics of the signal of such AP or other device may also be recorded or stored. The method may then return to block 302 where the device may again wait a silent channel dwell time to listen for other APs or devices transmitting on such channel.

Returning to block 310, if the total elapsed scanning time is greater than the pre-determined scanning time span the device may save or store the collected data about the APs or other devices that it detected on the channel being scanned, and may terminate its scan of the channel and proceed to a next channel to be scanned. Other operations or series of operations may be used.

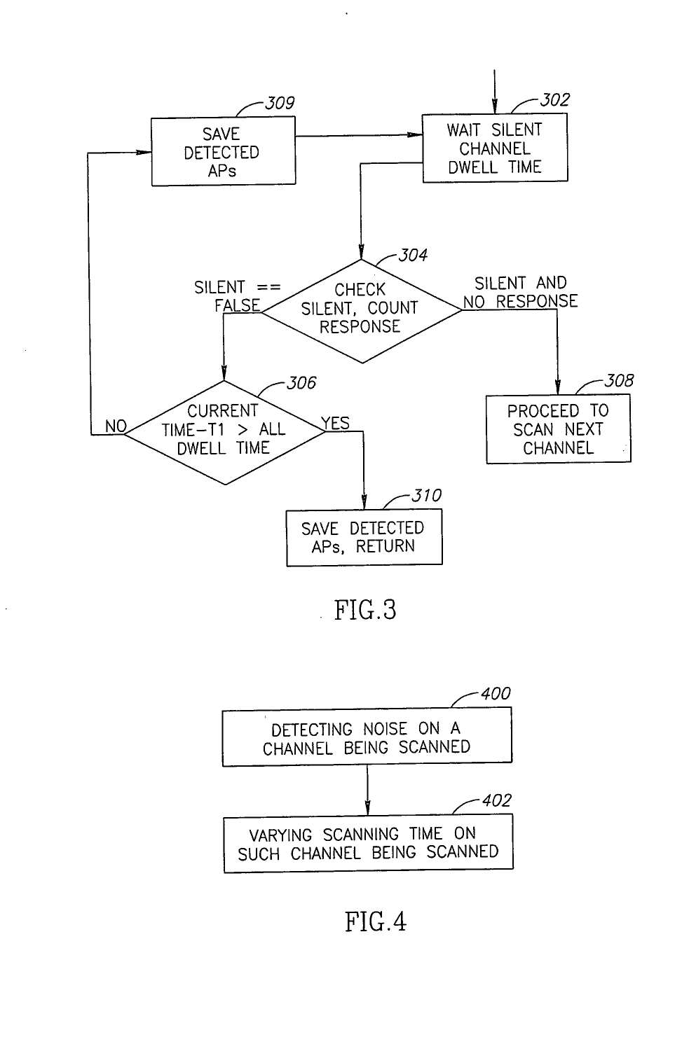

Reference is made to FIG. 4, a flow chart of a method in accordance with an embodiment of the invention. The embodiment of the method depicted in FIG. 4 may be used in conjunction with that depicted in FIGS. 2 and 3, but need not be, and may be used with an embodiment of a device and system such as that depicted in FIG. 1, but again need not be. Other suitable devices and systems may perform the embodiment of the method depicted in FIG. 4. In block 400 a device such as a station, laptop, NIC or other wireless communication device may, as part of for example an active scan of channels, detect traffic, transmission or network noise on a channel being scanned. Noise may include for example traffic on a channel, probe requests or probe responses issued on a channel, data transmitted on a channel or other transmissions between network or other devices on a channel. Such noise may be detected from for example other wireless devices that are broadcasting on such channel. The presence of such noise may be an indication that there is an AP or other device transmitting on such channel and that the device may choose to associate with such AP on such channel. In block 402, a processor or controller in such device may extend or otherwise vary the period or duration of a scan of a channel in response to the detection of traffic, transmission or network noise on such channel being scanned. In some embodiments, if no noise is detected on a channel being scanned and a device does not receive a probe response to a probe request during a brief dwell time, the processor or controller within the device may reduce the scan time on a channel and terminate a scan of such quiet channel after only a brief dwell period, and may continue a scan of a next channel. Other operations or series of operations may be used.

It will be appreciated by persons skilled in the art that embodiments of the invention are not limited by what has been particularly shown and described hereinabove. Rather the scope of at least one embodiment of the invention is defined by the claims below.

I claim:

1. A method of scanning comprising varying the duration of scanning on a channel if noise is detected on said channel.

2. The method as in claim 1, comprising varying said scanning duration on said channel if a probe response is received on said channel.

3. The method as in claim 1, wherein said varying comprises increasing said scanning duration on said channel if noise is detected on said channel.

4. The method as in claim 1, comprising detecting noise on said channel.

5. The method as in claim 1, comprising listening for noise on said channel.

6. The method as in claim 1, comprising recording a detection of noise on said channel.

7. The method as in claim 1, comprising recording data about a device detected as transmitting on said channel.

8. The method as in claim 1, wherein said varying comprises extending said scanning duration on said channel up to a pre-determined duration if noise is detected on said channel.

9. A device for scanning comprising a controller to vary a period of scanning of a channel in response to noise detected on said channel.

10. The device as in claim 9, wherein said controller is to vary a period of scanning of a channel in response to an access point detected on said channel.

11. The device as in claim 9, wherein said controller is to reduce said period of scanning on said channel if noise is not detected on said channel.

12. The device as in claim 9, wherein said controller is to record the presence of noise on said channel.

13. The device as in claim 9, wherein said controller is to detect noise on said channel.

14. An article comprising a storage medium, having stored thereon instructions, that when executed, result in varying a duration of scanning on a channel in response to noise detected on said channel.

15. The article as in claim 14, wherein said execution of said instructions further results in varying said duration of scanning on said channel in response to an access point on said channel responding to a probe request.

16. The article as in claim 14, wherein said execution of said instructions further results in reducing said duration of scanning on said channel if noise is not detected on said channel.

17. The article as in claim 14, wherein said execution of said instructions further results in recording a detection of noise on said channel.

18. A device comprising:
a dipole antenna; and
a processor to vary a period of scanning of a channel in response to noise detected on said channel.

19. The device as in claim 18, wherein said processor is to vary said scanning period on said channel in response to an access point on said channel responding to a probe request.

20. The device as in claim 18, wherein said processor is to record a detection of noise on said channel.

21. A communication system comprising:
a station that includes a controller to vary a period of scanning of a channel in response to noise detected on said channel and a memory to record said detection of noise on said channel.

22. The communication system as in claim 21, wherein said controller is to vary said scanning period on said channel in response to an access point on said channel responding to a probe request.

23. The communication system as in claim 21, wherein said controller is to record a detection of noise on said channel.
